(19) United States
(12) Patent Application Publication
(10) Pub. No.: US 2018/0260471 A1
(43) Pub. Date: Sep. 13, 2018

(54) USER GROUP FORMATION WITH COMPLEMENTARY SKILL SETS

(71) Applicant: Global Sustainability and Life Cycle Consultant LL, Watkinsville, GA (US)

(72) Inventor: Shankar R. Ghimire, Fairfax, VA (US)

(21) Appl. No.: 15/915,033

(22) Filed: Mar. 7, 2018

Related U.S. Application Data
(60) Provisional application No. 62/468,016, filed on Mar. 7, 2017.

(51) Int. Cl. G06F 17/30; G06F 3/0482

(52) U.S. Cl. CPC G06F 17/30598; G06F 3/0482; G06F 17/3053

(57) ABSTRACT

A computer implemented system allows a larger number of users to input their complementary skills, interest and expertise in an online platform and forms a plurality of groups of users or members), each group being formed based on their skills, interest, complementary skills, expertise and the user inputted parameters for the skills and expertise such that the skills and expertise of the users in a formed group are complementary to each other such the group as a whole has all the necessary skills and expertise as defined by the user to complete and project or task. An interface is provided for the investors or state/government bodies to score the groups and invest on the groups based on the scores. The members can change the groups or the groups can swap or exchange the members to match and configure the skills, complementary skills, expertise and interest in the groups, and maximize the score of one or more groups. The investors and state/government bodies can participate to pay the members.

This application claims priority to Provisional Patent Application No. 62/468,016, filed on Mar. 7, 2017, which is incorporated herein in its entirety by reference.

### FIELD

Example embodiments of the inventive concepts relate to user group formation.

### BACKGROUND

U.S. Pat. No. 7,231,206 B2 discusses group application for group formation and management in a wireless environment. US 20030046343 A1 discusses group formation based on IP address.

### SUMMARY

In an example embodiment, a computer implemented system for grouping a plurality of users based on user expertise, skills and interests comprises: a server, comprising a processor and a memory, the memory including a non-transitory computer-readable-medium having computer-executable instructions stored therein that, when executed by the processor, cause the processor to: prompt a user to input a first set of one or more terms in a GUI interlace; compare the first set of one or more inputted terms on the fly with a plurality of stored terms in a database and suggest and display a second set of plurality of selectable terms to the user in response to the user inputting the first set of one or more terms, the second set of the plurality of selectable terms including the user inputted terms; in response to the user selecting the second set of plurality of selectable terms, store the second set of plurality of selectable terms and prompting the user to input a third set of one or more terms in a GUI interface; compare the third set of one or more inputted terms on the fly with a plurality of stored terms in a database and suggest and display a fourth set of plurality of selectable terms to a user in response to the user inputting the third set of one or more terms, the fourth set of plurality of selectable terms including the user inputted terms; in response to the user selecting the fourth set of plurality of selectable terms, store the fourth set of plurality of selectable terms and prompting the input a fifth set of one or more terms in a GUI interface; compare the fifth set of one or more inputted terms on the fly with a plurality of stored terms in a database and suggest and display a sixth set of plurality of selectable terms to a user in response to the user inputting the fifth set of one or more terms, the sixth set of plurality of selectable terms including the user inputted terms; in response to the user selecting the sixth set of the plurality of selectable terms, store the sixth set of plurality of selectable terms and prompting the user to input a seventh set of one or more terms in a GUI interface; compare the seventh set of one or more inputted terms on the fly with a plurality of stored terms in a database and suggest and display an eighth set of plurality of selectable terms to a user in response to the user inputting the seventh set of one or more terms, the eighth set of plurality of selectable terms including the user inputted terms; in response to the user selecting the eighth set of the plurality of selectable terms, store the eighth set of plurality of selectable terms and prompting the user to input a ninth set of one or more terms in the GUI interface; compare the ninth set of one or more inputted terms on the fly with a plurality of stored terms in a database and suggest and display a tenth set of plurality of selectable terms to the user in response to the user inputting the ninth set of one or more terms, the tenth set of plurality of selectable terms including user inputted terms; in response to the user selecting the tenth set of the plurality of selectable terms, store the tenth set of plurality of selectable terms; wherein, the second set of the plurality of terms, the fourth set of the plurality of terms, the sixth set of the plurality of terms, the eighth set of the plurality of terms, and the tenth set of the plurality of terms include meta data related to the user inputting these terms.

In an example embodiment, the steps of inputting the terms is repeated until the twelfth set of the plurality of terms, the fourteenth set, of the plurality of terms, the sixteenth set of the plurality of terms, the eighteenth set of the plurality of terms, and the twentieth set of the plurality of terms are stored.

In an example embodiment, a method for grouping a plurality of users based on user expertise, skills and interests comprises: sending a plurality of user skill information (self-skill) and an associated ranking from a large number of users, each user skill information being inputted by the users in separate instances or in separately enabled fields; sending a plurality of user interest information and associated ranking from the large number of users, each user interest information being inputted by the users in separate instances or in separately enabled fields; sending user expertise information and associated ranking from the large number of users, each user expertise information being inputted by the users in separate instances or in separately enabled fields; sending a plurality of complementary skill information and associated ranking from the lame number of users, each user complementary skill information being inputted by the users in separate instances or in separately enabled fields; sending a plurality of expertise information and associated ranking from the large number of users, each user expertise information being inputted by the users in separate instances or in separately enabled fields; receiving at least one of the plurality of user skill information (self skill) and the associated ranking, the plurality of user interest information and the associated ranking, the plurality of complementary skill information and the associated ranking, and the plurality of expertise information and the associated ranking, and forming an instant group formation (IGF) matrix by,
storing in a memory the interest information, skill information, complementary skills information, and expertise information corresponding to a first user in a first row in columns 1-n, with ranking; storing in the memory the interest information, skill information, complementary skills information, and expertise information corresponding to a second user in a second row in columns 1-n with ranking;
storing in the memory the interest information, skill information, complementary skills information, and expertise information corresponding to a third user in a third row in columns 1-n with ranking; storing in the memory the interest information, skill information, complementary skills information, and expertise information corresponding to a fourth user in a fourth row in columns 1-n with ranking; storing in the memory the interest information, skill information, complementary skills information, and expertise information corresponding to a filth user in a fifth row in columns 1-n with ranking; repeating the steps of storing, in the memory, the interest information, skill information, complementary skills information, and expertise information corresponding to each of the remaining users until all the user information is stored; and
forming a first group of users based on the self-skills, complementary skills, expertise and interest in such a way that each of the complementary skills associated with a same user (a first member of the group) is searched in the self-skill columns of remaining users wherein first, the first column is searched for the complementary skills, if a corresponding complementary skill is round in the first column, the corresponding user is selected as a second member of the group, if the complementary skill is not found in the first column, the second column is searched for the same complementary skill and the corresponding user will be selected as the second member of the group, the process is repeated until all the complementary skills and expertise are identified, and a group is formed wherein the formed group incorporates all the necessary skills and expertise to complete a function.

In another example embodiment, the associated ranking indicates the user command or strength on the skills in numerical representation with 1 being the best and 10 being the least in ranking. In another example embodiment, the self-skills, complementary skills or expertise are selected from the order of best available rankings to the least available rankings.

In yet another example embodiment, a computer implemented system for grouping a plurality of users based on user expertise, skills and interests comprises: a server, comprising a processor and a memory, the memory including a non-transitory computer-readable-medium having computer-executable instructions stored therein that, when executed by the processor, causes the processor to:
receive, from each user from a plurality of users, a first set of a plurality of a user information associated with the user, the first set of a plurality the user information further including ranking for the each of the user information; receive, from each of the plurality of users, a second set of information determined by the user, the second set of information including information associated with the users other than the user himself and ranking for the each of the second set of information; and form a group of users comprising a first user and a second group of users, the first user being selected from one of the plurality of users based on a criteria and the second group of users being, selected based on the second set of information determined by the first user.

In an example embodiment, the first set of the plurality of user information are a set of skill information associated with the user (i,e., self-skill), the set of skill information being ranked from 1-5 with l being the best skill.

In an example embodiment, the second set of the plurality of user information are a set of skill information that the user is looking for in other users (i,e., the complementary skill set), the complementary skill set being ranked from 1-5 with 1 being the best skills.

In an example embodiment, forming the group of users comprises: selecting: the second group of users by,
searching each information of the second set of information determined by the first user, in the self-skill set of information inputted by the other users in the order of ranking, and if the searched information is found, selecting the corresponding users as member of the second group of users; and forming the group of users by including first. user and the second group of users.

In an example embodiment, the formed group is displayed along with an overall score of the group.

In an example embodiment, the overall score of the group is updated based on the score provided by second set of a plurality of users.

In an example embodiment, the system is configured to mutually swap individual users (a member of a group) with another individual member of the group.

In an example embodiment, the second group of the plurality of users are selected by,
in a first step, searching a complementary skill in rank 1 of the users self-skill information and if a corresponding complementary skill is found in rank 1, the corresponding user is selected, then,
repeating the first step until all the complementary skills are searched in rank 1, and the corresponding users are selected, and if all the complementary skills are not found in rank 1, repeating step 1 in rank 2, rank 3, rank 4 or rank 5 in order until all the complementary skills are identified

In an example embodiment, the second group of the plurality of users are selected by,
in a second step, searching a complementary skill in rank 2 of the users self-skill information if a corresponding complementary skill is not found in rank. 1, and if the complementary skill is found in rank 2, the corresponding user is selected, then,
repeating the second step until all the complementary skills are searched in rank 2, and the corresponding users are selected.
In an example embodiment, the second group of the plurality of users are selected by,
in a third step, searching a complementary skill in rank 3 of the users self-skill information if a corresponding complementary skill is not found in rank 2, and if the complementary skill is found in rank 3, the corresponding user is selected, then,
repeating the third step until all the complementary skills are searched in rank. 3, and the corresponding users are selected; and
repeating third step with remaining ranks until all, the complementary skills are found and selecting the corresponding users.

In an example embodiment, the ranking information is from 1-5, 1 being, the best representative of the user information.

In an example embodiment, the user information is the information inputted by the user in a graphical user interface, each user information being inputted in separately enabled interlace and the interface further comprising ranking information selectable between 1-10.

### BRIEF DESCRIPTION OF THE DRAWINGS

The example embodiments of the inventive concept will be better understood from the following brief description taken in conjunction with the accompanying drawings. The drawing FIGS. 1-10 represent non-limiting, example embodiments.

FIG. 1 shows overview of user group formation, according to an example embodiment

FIG. 2 shows computer communication, components and interconnection, according to an example embodiment.

FIG. 3 shows various terminals and interconnection, according to an example embodiment,

FIG. 4 shows user input data interface and database formation from the user input data, according to an example embodiment.

FIG. 5A shows steps 1-7 involved in group formation, according to an example embodiment.

FIG. 5B shows steps 8-14 involved in group formation, according to an example embodiment,

FIG. 6 shows interconnection of the electrical components and modules used in group formation, according to an example embodiment.

FIG. 7. shows interconnection of the electrical components and modules used in a search, identification, and group formation system, according an example embodiment.

FIG. 8 shows XY and radial mapping of the various self-skills, complementary skills, and expertise of the of a single user, for a plurality of product models envisioned by a single user, according an example embodiment.

FIG. 9 shows group formation model overview, according to an example embodiment.

FIG. 10 shows word diagram for group formation, according, to an example embodiment.

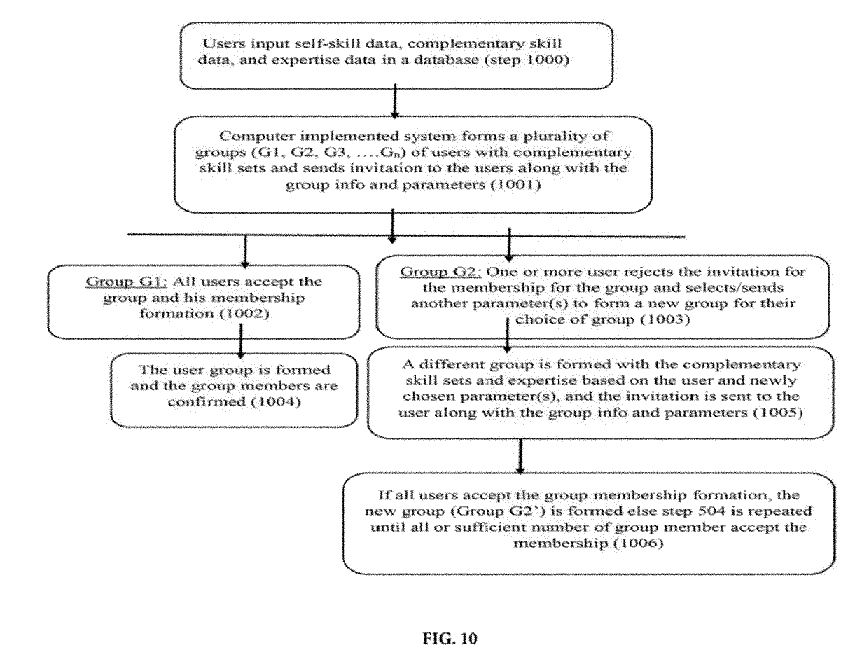

### DETAILED DESCRIPTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art, in the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

A system and method for reducing unemployment is provided. A computer implemented system allows a larger number of users to input their skills, interest and expertise in a database. Each user can input a set of parameters to form a group. These parameters represent available skill sets and the new skills sets that the user is looking for in his members to form a group. In an example embodiment, the computer implemented system forms groups of a plurality of users based on their interest, and user inputted parameters for their skills and expertise and the user inputted parameters for the complementary skills and expertise (the skills and expertize the user is looking for/demanding for his group) such that the skills and expertise of the users in a formed group are complementary to each other. For each term or parameter used or selected, the system connects the terms by the metadata associated with the user information such that the group members may be related based on their skills or expertize. The method provides an interface where investors may assign scores to each group formed to provide ranking of the formed groups based on the investors criteria and based on the group expertise and skills. The investors than invest money based on the ranking of each group. The system also allows the group members to change the groups (swapping members) to optimize (or maximize) the ranking of the groups based on the matching profile and skills of the users. The user members are paid based on the investment made on the group by the investors and by the participating state and government bodies.

In an example embodiment, the computer implemented system groups a plurality of users based on their interest, and user selected/inputted terms for their skills and expertise and user selected/inputted terms for the complementary skills and expertise such that skills and expertise of the users in the group are complementary to each other. For each term used or selected, the system connects the terms by metadata associated with the user information.

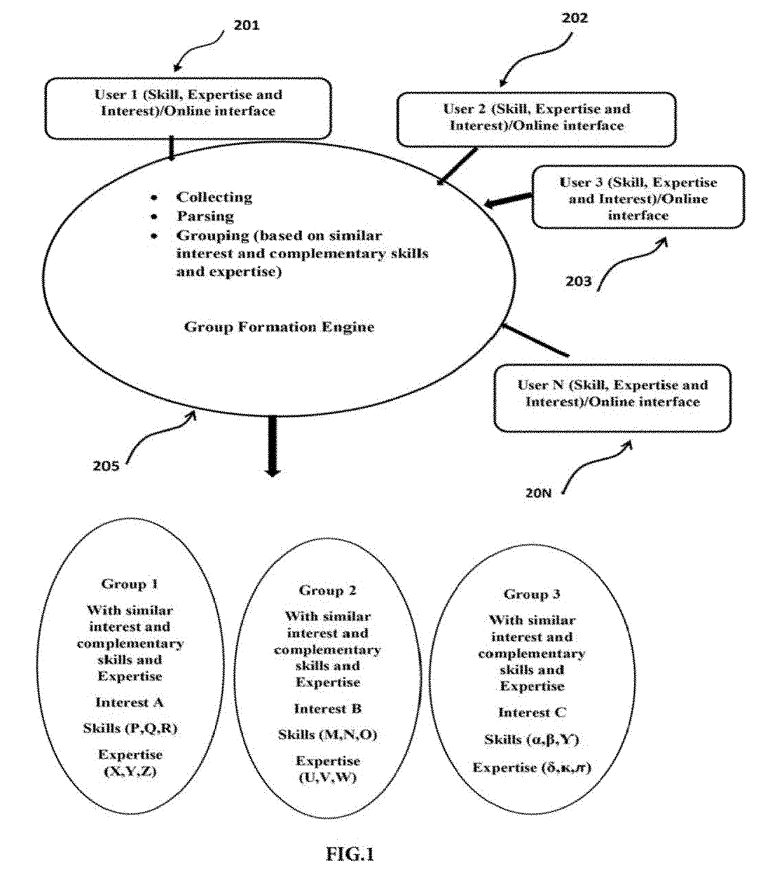

FIG. 1 shows an example embodiment of group formation. User 1 inputs his skills, interest and expertise in an online interface 201. Such skills include a plurality of his own skill set and a plurality of skill set he is looking for (demanding for) in a team he is going to form. User 2 inputs his skills, interest and expertise in an online interface 202. Such skills include a plurality of his own skill set and a plurality of skill set he is looking for (demanding for) in a team he is going to form, User 3 inputs his skills, interest and expertise in an online interface 203. Such skills include a plurality of his own skill set and a plurality of skill set he is looking for (demanding for) in a team he is going to form. Similarly, the user N (if there are 1, 2, 3, 4, . . . N number of users) inputs his skills, interest and expertise in an online interface 20N (not shown). Such skills include a plurality of his own skill set and a plurality of skill set he is looking for (demanding for) in a team he is going to form.

In an example embodiment, the group formation engine 205 collects the inputted information by the users (for example users 1, user 2, user 3, user 4, . . . and user N), parses the information and groups based on similar interests, user's skill set, complementary skill set (skill set he is looking for in other users) and expertise the user is looking for in a group he or she is forming. The group formation is further described in practical EXAMPLE SCENARIO 1, and 2 below.

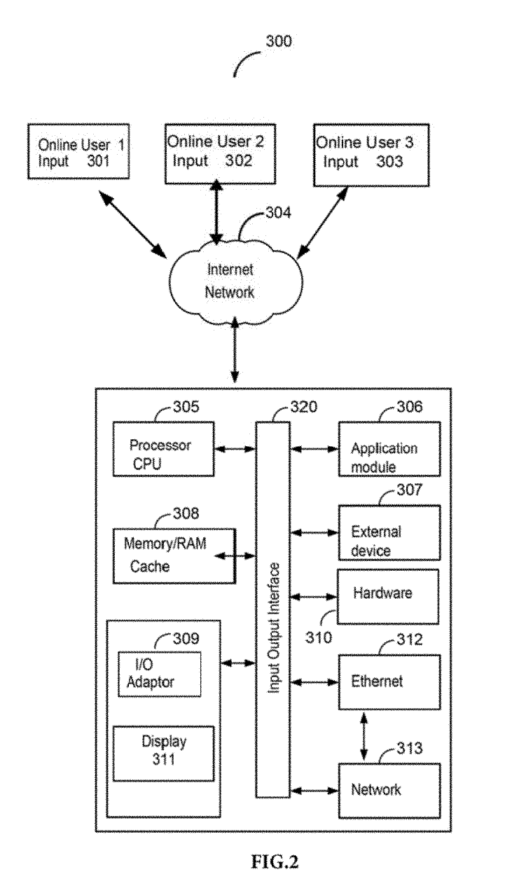

FIG. 2 shows network and computer interconnection for user input and group formation system 300, according to an example embodiment. Online users input at the terminals 301, 302, 303 are received by the computer 314 via network 304. Application module 306 parses the collected/received data/information and forms groups based on similar interest, user's skill set and complementary skill sets as described in EXAMPLE SCENARIO 1, and 2.

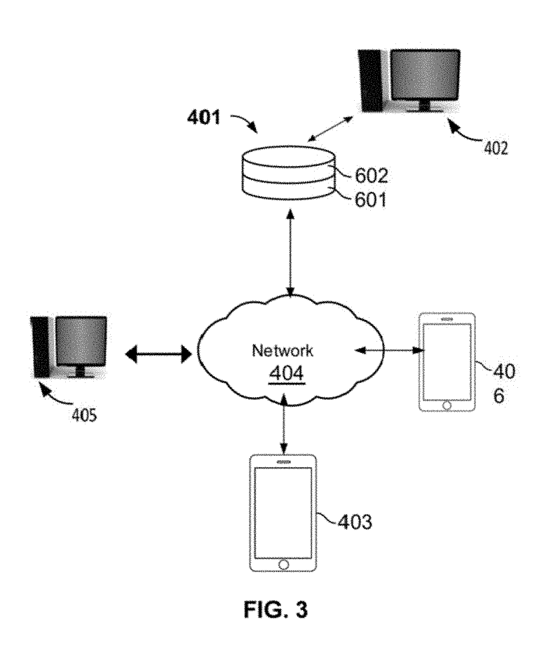

FIG. 3 shows mobile terminals 403 and 406; data server 401 and user computers 405, 402, that are interconnect via network 404, according an example embodiment.

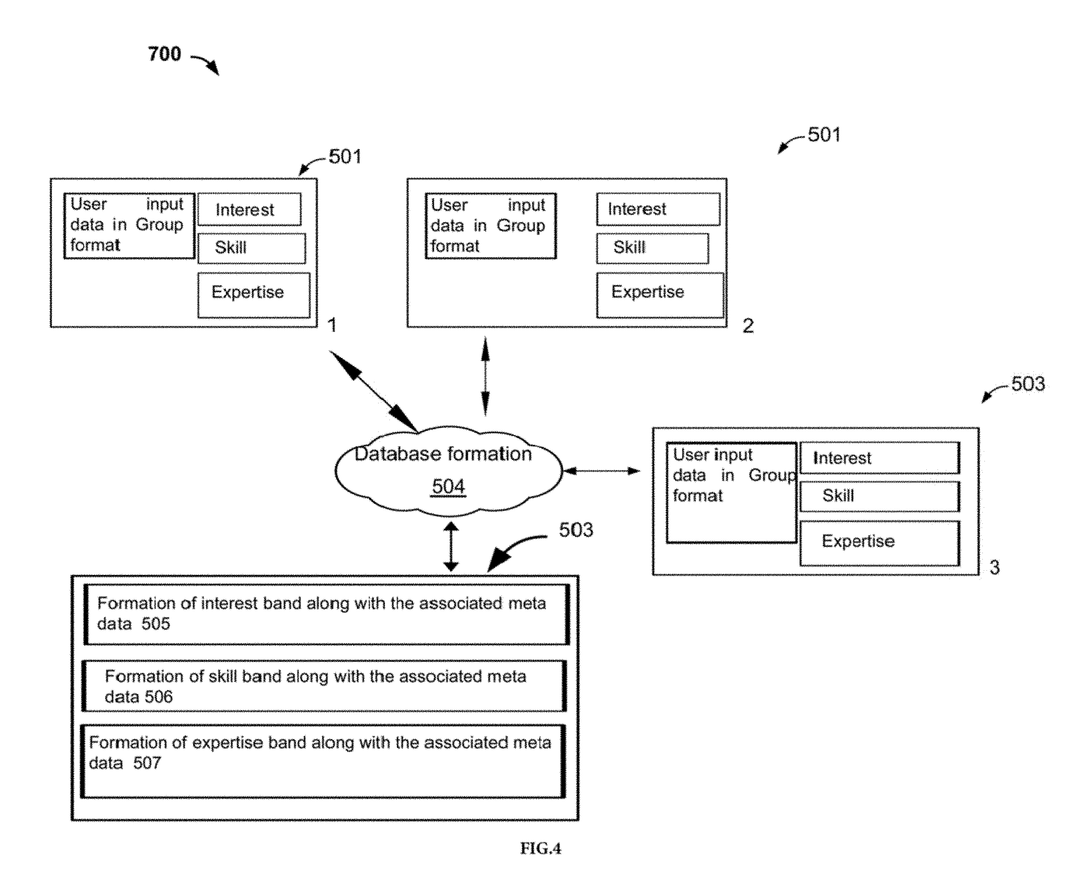

FIG. 4 shows detail of user input data interface and database formation from the user input data according to an example embodiment. For example, interest data, skill data and expertise data are entered separately. Interfaces 501, 502, and 503 represent interface for different users. The entered data are received and a database 504 is formed. In an example embodiment, interest band is formed along with the associated metadata at step 505. The interest band include interest data for a large number of users with similar or gradually changing interest information. In an example embodiment, skill band is formed along with the associated metadata at step 506. The skill band include skill data for a large number of users with similar or gradually changing skill information, in an example embodiment, skill band is formed along with the associated metadata at step 506. The expertise band include expertise data for a large number of users with similar or gradually changing expertise information. In an example embodiment, expertise band is formed along with the associated metadata at step 507.

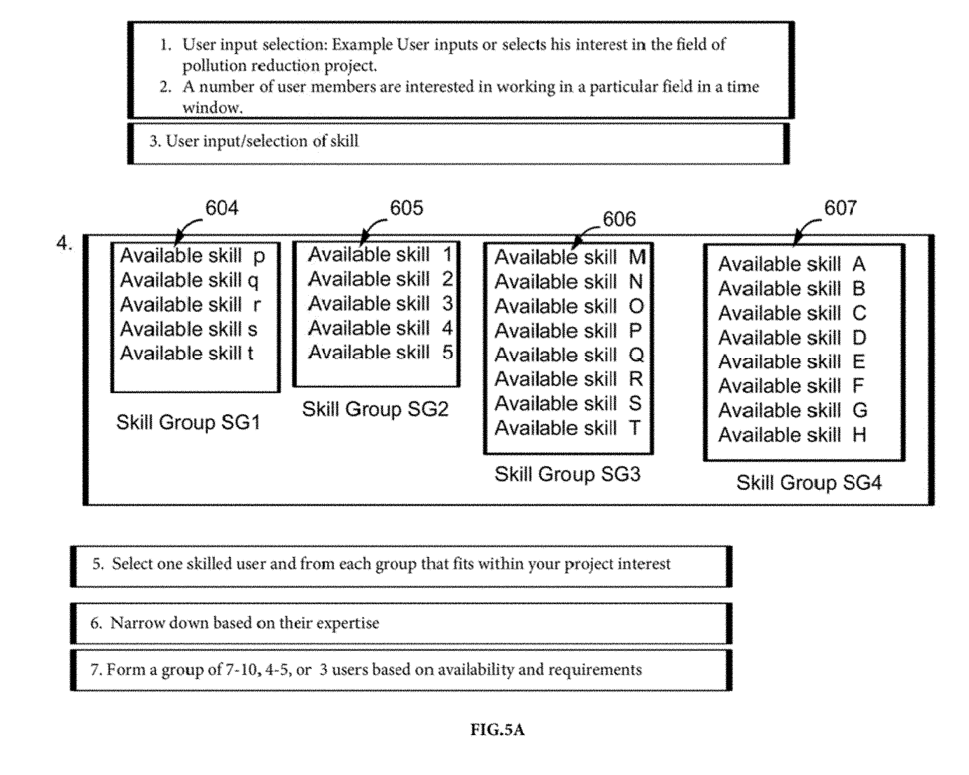

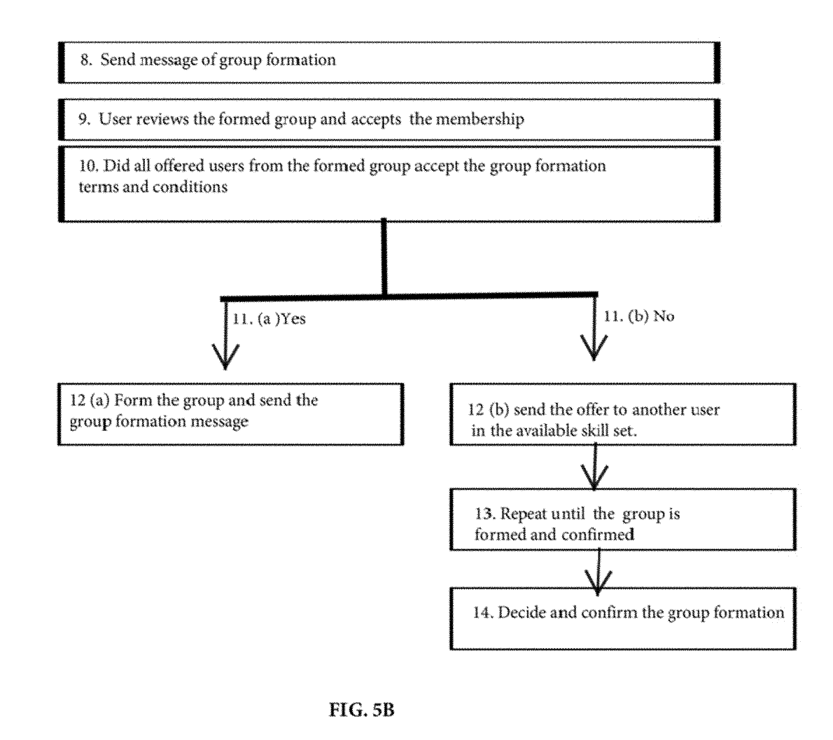

FIG. 5 shows steps involved in group formation. In an example embodiment, at step 1, a user inputs or select a field of interest. In step 3, user inputs or selects skills (self-skills and complementary skills). Skill group 1 has available skills p, q, r, s, t. Skill group 2 has available skills 1, 2, 3, 4, 5. Skill group 3 has available skills M, N, O, P, Q, R, S, T. Skill group 4 has available skills A, B, C, D, F, F, G.

In step 5, a user can select the skill he is looking for from each group that fits within his project interest. Such selection of users are narrowed down based on their expertise. In step 8, group formation message is sent. In step 9, user reviews the formed group and accepts the group membership to be dedicated for the group. In step 10, when all the users accept the terms and condition, group formation is confirmed and message is sent to the group members. In step 11(b), if a member does not accept the terms and condition a new member is invited in the group and the above process is repeated until all the invited members accept the membership in the group.

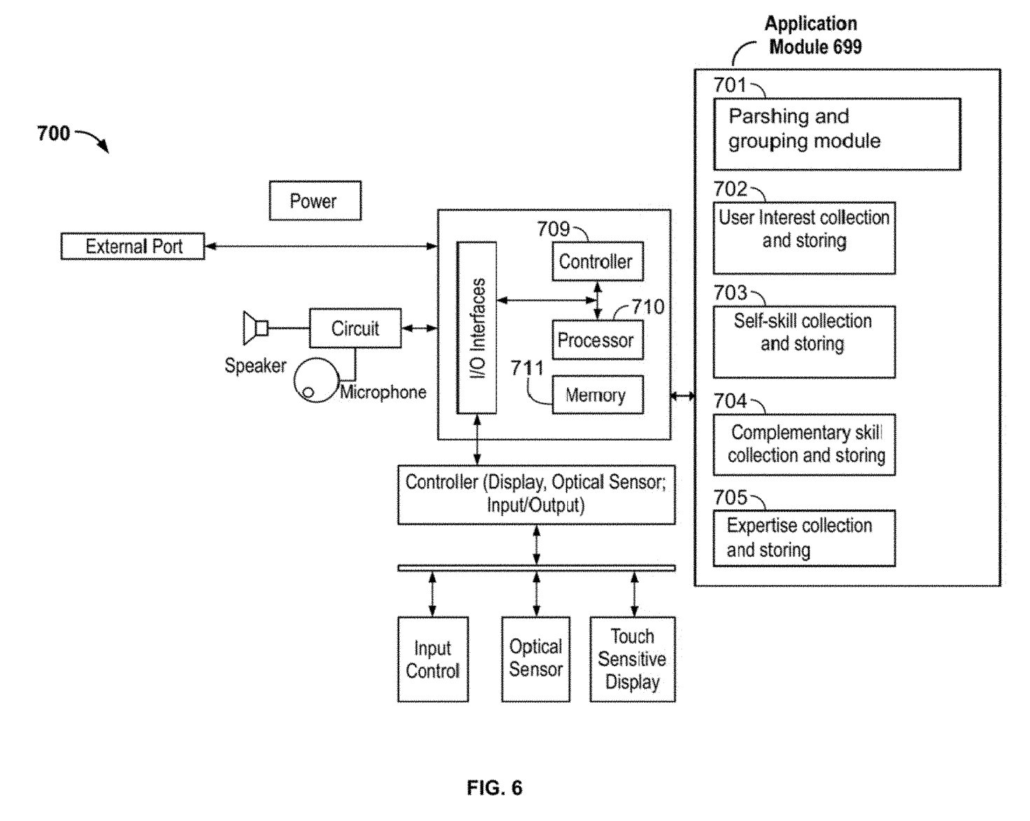

FIG. 6 shows interconnection of the electrical components and modules used in group formation, according to an example embodiment.

In an example embodiment, a computer implemented system 700 for grouping a plurality of users based on user expertise, skills (self-skills and complementary skills) and interests may be residing inside a data server system 401 or may be residing outside the server and data is received from the server and processed.

In an example embodiment, the computer implemented system 700 for grouping a plurality of users based on user expertise, skills and interests, comprises a data server 401, comprising a processor 710 and a memory 711, the memory including a non-transitory computer-readable-medium having computer-executable instructions stored therein that, when executed by the processor, causes the processor to, receive, from each user from a plurality of users (for example mobile users 403, 406, . . . , . . . ), receive, from each user from a plurality of users, a first set of a plurality of a user information associated with the user, the first set of a plurality the user information further including ranking for the each of the user information; receive, from each of the plurality of users, a second set of information determined by the user, the second set of information including information associated with the users other than the user himself and ranking for the each of the second set of information; and select a group of users comprising a first user and a second group of users, the first user being selected from one the plurality of user based on a criteria and the second group of users being selected based on the second set of information determined by the first user. Such group formation is also described in section entitled GROUP FORMATION USING USER 1.

The user information may be received online through wired or wireless network. The first set of the plurality of user information are a set of skill information associated with the user (i.e., the users own skill or self-skill), the set of skill information being ranked from 1-5. The second set of information are a set of skill information that the user is looking for in other users (i.e., the complementary skill set), the complementary skill sets are ranked from 1-5 In some embodiments, the complementary skill sets are not ranked.

In an example embodiment, application module is a combination of a plurality of modules and is configured to parse, search, select and form group from the information received from the plurality of users. Parsing and module 701 receives the user input data from a grouping plurality of users and parses and groups in a band of skill information data and attaches the metadata associated with the users. Self-skill collection and storing module 703 ranks the data based on the user input information about the self-skill information and stores in a memory. Complementary skill collection and storing module 704 collects and stores the complementary skills in a memory. Along with the self-skill and complementary skills, the user interest and expertise data are stored in a row for each user. Each row represents each user inputted information. Such data are collected and stored for a large number of users (For example users 1-N, N being a number representing a population) to form a matrix, an instant group matrix (IGM). After formation of IGM, it is a matter of individual user clicking a button to form his team based on his skills (self-skill) and complementary skills be has already determined and inputted in the system. An exemplary content of an IGM is shown in Table 2.

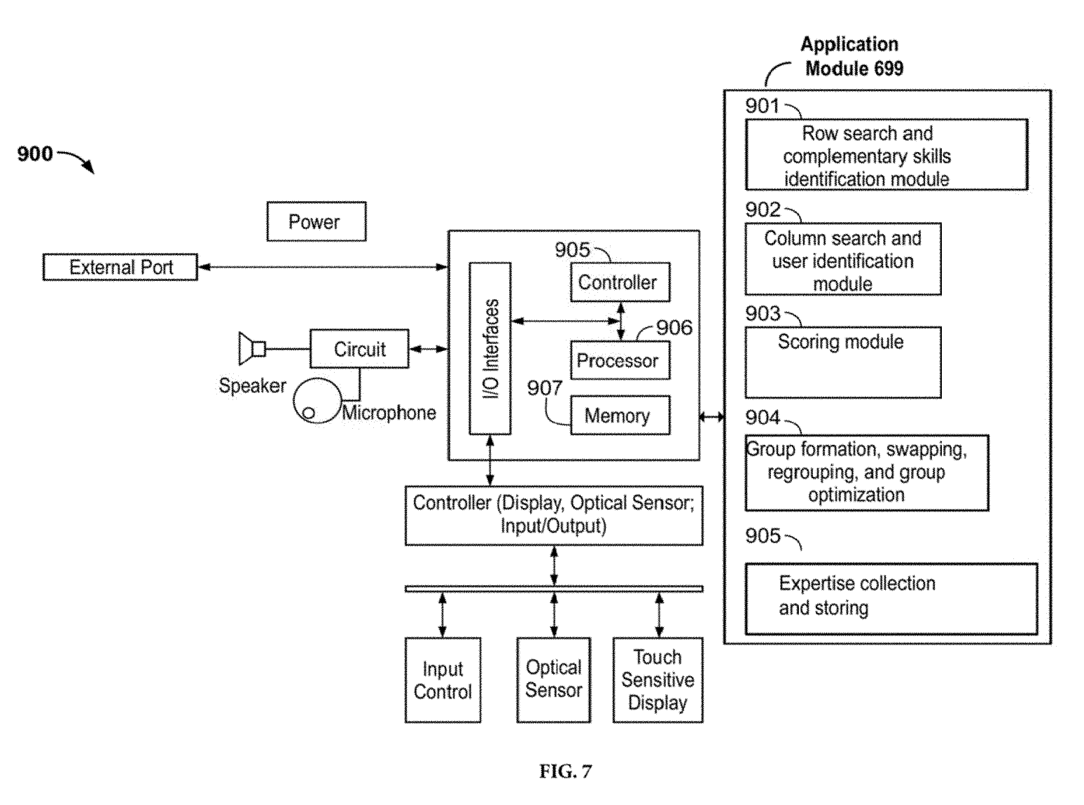

FIG. 7. shows interconnection of the electrical components and modules used in a search, identification and group formation system, according an example embodiment. The row search and complementary skill identification module 901 searches through the complementary skills in a row associated with a user and identifies a similar skill in a column search with rank 1 to find a group member for the user having a self-skill corresponding (similar to or the same as) to the first complementary skill. The complementary skill identification module 901 repeats the search and identification of the user in columns and identities the members with self-skills (complementary skills) with highest ranking available. After finding all the users with self-skills similar to or same as the complementary skill a group is formed and returned to the corresponding user who determined or identified the complementary skills. Scoring module 903, receives the score provided by a plurality of outside users for each groups formed and ranks the formed group in the order of the scores received. Group formation, swapping, regrouping and group optimization module 904 compares score data among the formed groups, and suggest options for the group forming users (i.e., to the group former, the group leader) to swap members of the group to best represent the skill set and interest for performing a job or project. Accordingly, in an example embodiment, the score of the group may be increased after swapping group members with suitable skill sets.

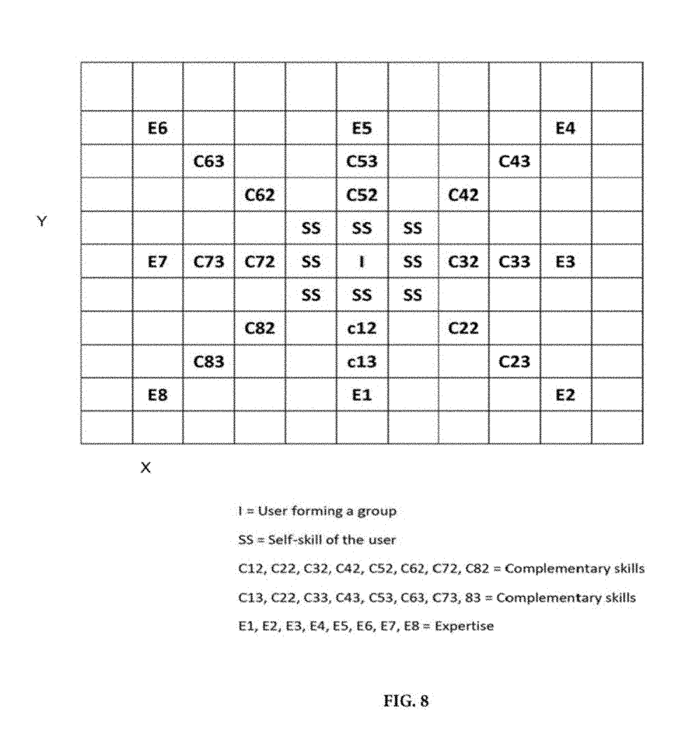

FIG. 8 shows XY and radial mapping of the various self-skills, complementary skills, and expertise of the of a single user, for a plurality of product models envisioned by a single user, according an example embodiment. Each IGM matrix can be expanded along the Z axis for each line in XY. For different self-skills (SS), a user can envision different product model and he can determine different sets of complementary skills (C12, C13, C22, C23, C32,C33, C42, C43, C52, c53, C62, C63, C72 C73, C82, C83).

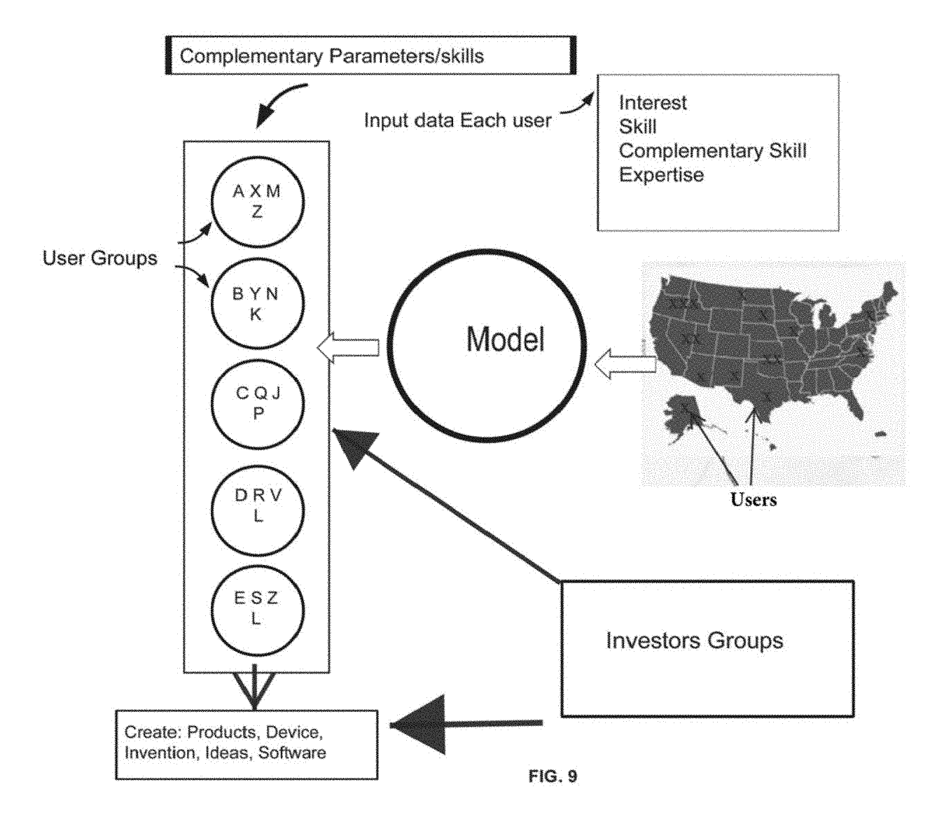

FIG. 9 shows group formation model according to an example embodiment. The user from all across a country (for example USA) seeking employment/opportunity would login and input their skills expertise, complementary skills and interest into the online system. The tool forms the users' groups with a complete set of complementary skills to develop, device, software, product, or a tool. Investors invest money and assign scores on the groups formed. In fully functional mode, the tool involves a large-scale data mining from a large number of users. This online tool allows users to instantly form a collaboration team with all necessary skill sets and expertise to complete a project or to develop a product or a tool. In an example embodiment, the group formation also involves hierarchy formation among the members, forming appropriate groups and subgroups based on a plurality of criteria. The tool allows the team members to interface with the investors, and product development teams, marketing and manufacturing teams. The tool will also interface with government agencies to add automated supporting means to pay for the unemployment benefits to the members as they form their collaboration team and start working. Thus, in an example embodiment, as the as the new members register, they will he automatically registered for (un)employment benefit. Considering a large number of people (millions) looking for new opportunities, there will be a large number of incoming members (new members) and outgoing members when the tool is fully functioning. Therefore, the tool also includes database centers to accommodate new joining members and see-off the current members from the group as they land on to the new opportunity.

The tool may also include a platform for the investors to fund a project/team. Separate functions are added in the tool for assisting users in investment, intellectual property protection, interaction with the team members, reorganization of the team based on the investors' interest and product development or to reorganize and add additional experts in a group already formed. The investors will be provided an opportunity to score a team, and review and rank the teams based on different criteria.

Example Scenario 1

In an example embodiment, each user inputs four sets of information via a user interface. In the first set of information, the user inputs his five best skills. In the second set of information, the user inputs four complementary skills sets he is looking for in his group, and in the third set of information the user inputs his expertise (self-expertise). In the fourth set of information, the user inputs the expertise he is looking for the group.

The complementary skills indicate the skills that are needed for the group that complement the already available skills. The complementary skills together with the users skills set provide all the necessary skills set for the group to perform the research and development and business creation as chosen by the user who intends to form the group,

Table 1 shows such information in tabular form.

TABLE 1

| | | | | | | | | | | Expertise | |
|---|---|---|---|---|---|---|---|---|---|---|---|
| | | | | | | | | | | col. 10 | |
| | Self-Skills | | | | | Complementary skills | | | | Expertise | col. 11 |
| | col. 1 | col. 2 | col. 3 | col. 4 | col. 5 | col. 6 | col. 7 | col. 8 | col. 9 | for the | Self- |
| Users | Skills | Skills | Skills | Skills | Skills | Skills | Skills | Skills | Skills | group | expertise |
| 1 | s1, 1 | s1, 2 | s1, 3 | s1, 4 | s1, 5 | c1, 6 | c1, 7 | c1, 8 | c1, 9 | ce1, 10 | se1, 11 |
| 2 | s2, 1 | s2, 2 | s2, 3 | s2, 4 | s2, 5 | c2, 6 | c2, 7 | c2, 8 | c2, 9 | ce2, 10 | se2, 11 |
| 3 | s3, 1 | s3, 3 | s3, 3 | s3, 4 | s3, 5 | c3, 6 | c3, 7 | c3, 8 | c3, 9 | ce3, 10 | se3, 11 |
| 4 | s4, 1 | s4, 4 | s4, 3 | s4, 4 | s4, 5 | c4, 6 | c4, 7 | c4, 8 | c4, 9 | ce4, 10 | se4, 11 |
| 5 | s5, 1 | s5, 5 | s5, 3 | s5, 4 | s5, 5 | c5, 6 | c5, 7 | c5, 8 | c5, 9 | ce5, 10 | se5, 11 |
| 6 | s6, 1 | s6, 6 | s6, 3 | s6, 4 | s6, 5 | c6, 6 | c6, 7 | c6, 8 | c6, 9 | ce6, 10 | se6, 11 |
| 7 | s7, 1 | s7, 7 | s7, 3 | s7, 4 | s7, 5 | c7, 6 | c7, 7 | c7, 8 | c7, 9 | ce7, 10 | se7, 11 |
| 8 | s8, 1 | s8, 8 | s8, 3 | s8, 4 | s8, 5 | c8, 6 | c8, 7 | c8, 8 | c8, 9 | ce8, 10 | se8, 11 |
| 9 | s9, 1 | s9, 9 | s9, 3 | s9, 4 | s9, 5 | c9, 6 | c9, 7 | c9, 8 | c9, 9 | ce9, 10 | se9, 11 |
| 10 | s10, 1 | s10, 2 | s10, 3 | s10, 4 | s10, 5 | c10, 6 | c10, 7 | c10, 8 | c10, 9 | ce10, 10 | se10, 11 |

For user 1, skills s1,1-S1,5 are inputted best self-skills (the user own skills that are inputted by the user who intends to form the group) in order, the highest best skill in col. 1 and the least best skill in col 6. c1,6-c1,9 are the complementary skills the user is looking for the team so that the combination of the self-skills and complex complementary skills would provide all the necessary skills for the group to perform the research and development and business creation. ce1,10 is the expertise he is looking for the group and se1,11 is the expertise he possesses.

Similarly, for user 2, s2,1-s2,5 are his best self-skills in order with the highest best skill in col. 1 and the least best skill in col 6. c2,6-c2,9 are the complementary skills he is looking for the group, ce2,10 is the expertise he is looking for for the group and se2,11 is the expertise he possesses.

Similarly, for user 10, s10,1-s10,5 are his best self-skills in order with the highest best skill in col. 1 and the least best skill in col 6. c10,6-c10,9 are the complementary skills he is looking for the group. ce10,10 is the expertise he is looking for for the group and se10,11 is the expertise he possesses.

Group Formation Using User 1

In an example embodiment, user 1 is selected for his skill s1,1, which is the best skill from the skill sets (s1,1-s1,5) the user has inputted. Now the complementary skill c1, 6 is searched in first column of entry from the remaining users. If complementary skill is found in the first column, then the corresponding user is selected as a member of the group. If complementary skill c1,6 is not found in column 1, then the same skill (the complementary skill c1,6) is searched from column 2. The process is repeated until the best available complementary skill is found. Once the best available complementary skill is found, the user corresponding to the best complementary skill c1,6 is selected. This process is repeated to find users with the remaining best complementary skills c1,7, c1,8, and c1,9. Accordingly, a group of four users are selected based on the demand of the complementary skills sets chosen by the user 1. Including user 1, a total of five users are selected to form a group that encompasses the necessary skill sets to complement each other and available expertise and interest in the group necessary to form a group of users to conduct business, research and development.

In an example embodiment, if an exact complementary skill sets are not found, then the close complementary skill sets are selected.

Next, an expertise for the group is searched for, if a self expertize is available from among the selected users, no additional member of the group is necessary. Else one more member with the self expertize as demanded by the user 1 is selected from the available users 2-10.

Thus, a group is formed having all the necessary skills and expertise as demanded by the user 1.

As described above, the inventive concept allows a user (user 1) to form a group according to his selected self-kills and his demanded (complementary) skills set and an expertize as chosen by the user (user 1).

Alternatively, the user also has an opportunity to become a member of a group formed according to the selected skills and demanded (complementary) skills by the other members) of the group.

Example Scenario 2 (Forming Group for Developing Tools for Science and Math Education)

The system first selects a croup of users who are interested in developing tools for math and science education for children. This first collection of users is done based on user inputted for selected) interest terms.

In this example scenario, exact input data information has been provided. This is just an exemplary scenario. This example scenario is rot intended to limit the disclosure in any way.

In an example embodiment, each user inputs four sets of information via a user interface. In the first set of information the user inputs his five best skills, in the second set of information the user inputs tour complementary skills sets he is looking for in his group, and in the third set of information the user inputs his expertise. In the fourth set of information, the user inputs the expertise he is looking for the group.

Table 2 shows such information in tabular form.

TABLE 2
Tool Development

| | Self-Skills | | | | | Complementary skills | |
|---|---|---|---|---|---|---|---|
| | col. 1 | col. 2 | col. 3 | col. 4 | col. 5 | col. 6 | col. 7 |
| | (rank 1) | (rank 2) | (rank 3) | (rank 4) | (rank 4) | (rank 6) | (rank 7) |
| Users | Skills | Skills | Skills | Skills | Skills | Skills | Skills |
| 1 | Research | Patent | Teaching | Sensor | electrical/ | CAD | Circuits |
| | and | | (physics | technology | electronics | drawing | and |
| | innovation | | math) | | | | instrumentation |
| 2 | Coding, | Business | IT | statistics | Research | packaging | antenna |
| | C++ | development | | | and | | |
| | | | | | innovation | | |
| 3 | Carbon | GIS | Sensor | Database | data | patent | Circuit |
| | pollution | mapping | development | management | integration | | and |
| | reduction | | | | | | instrumentation |
| 4 | Antenna | Optical | physics | Business | wireless | Mechanical | Robotics, |
| | development, | device | | development | | engineering | motors |
| | wireless | | | | | | |
| 5 | Green House | Environmental | Nano | Physics | sensor | Environmental | Bio |
| | gas | consulting | technology | | | science | sensors |
| 6 | CAD, | Graphics | Computer | Business | Research | Sensor | User |
| | drawing | | engineering | methods | and | technology | interface |
| | | | | | innovation | | development |
| 7 | Circuits and | GIS | Sensor | Database | data | patent | Carbon |
| | instrumentation | mapping | development | management | integration | | pollution |
| | | | | | | | reduction |

| | | | Expertise | |
|---|---|---|---|---|
| | | | col. 10 | |
| | Complementary skills | | (rank 10) | col. 11 |
| | col. 8 | col. 9 | Expertise | (rank 11) |
| | (rank 8) | (rank 9) | for | Self- |
| Users | Skills | Skills | the group | expertise |
| 1 | Coding, | Antenna | Research | Research |
| | C++ | development, | and | and |
| | | wireless | innovation | innovation |
| 2 | motherboards | circuits | — | toys |
| 3 | Computer | Environmental | material | |
| | science | science | | |
| 4 | programming | sensor | — | Flying |
| | | | | devices |
| 5 | Computer | Biomedical | Database | Environmental |
| | engineering | engineering | management | engineering |
| 6 | finance | Soft | patent | New business |
| | | skills | | method |
| | | | | technology |
| 7 | Physics | optics | — | Water |
| | | | | resource |
| | | | | mapping |

TABLE 3
Self-Skills

| col. 1 | col. 2 | | col. 4 | col. 5 |
|---|---|---|---|---|
| (rank 1) | (rank 2) | col. 3 (rank 3) | (rank 4) | (rank 4) |
| Skills | Skills | Skills | Skills | Skills |
| Research and | Patent | Teaching | Sensor | Electrical/ |
| Innovation | | (physics math) | Technology | electronics |

For example, the four self-skill information the user has inputted are in table 3.

These are users own skills, with research and innovation being the best among his best skills and electrical and electronics being his least among the best skills.

The complementary skills are the skills that are needed for the group that complement the already available skills. In other words, the user is demanding (looking for the member users with these complementary skills to form a group.

For example, the four complementary skill information the user has inputted are in Table 4—

TABLE 4

| Complementary skills | | | | Expertise | |
|---|---|---|---|---|---|
| col. 6 | col. 7 | col. 8 | col. 9 | col. 10 | col. 11 |
| Skills | Skills | Skills | Skills | Expertise for the group | Self-expertise |
| CAD drawing | Circuits and | Coding, C++ | Antenna | Research and innovation | Research and |
| | instrumentation | | development, | | innovation |
| | | | wireless | | |

Next, the user inputs expertise he is looking for for the group, and self-expertise which is his own expertise, For example—

Entry in column 10 (table 4) indicates that the research and innovation expertise is the expertise the use is looking for (demanded) for his group. For this user (the user1), he (user 1) has inputted his own self expertise as Research and innovation which indicates that the user 1 can provide the expertise in research and innovation.

Group Formation Using User 1

Next, the computer implemented system searches each of—
(i) CAD drawing skill, (ii) Computer engineering and Coding skill, (iii) C++ and (iv) Antenna development, wireless knowledge and skill,

in the first column. If any of the above skills are located in the first column then the user corresponding to that location (i.e. row) is selected as a group member. The process is repeated until all the complementary skills are found to identify the remaining group members. Accordingly, from table 2, the system selects users 2, 4, 6 and 7 to form the group.

Thus, the computer implemented system groups user 1, user 2, and user 4, user 6 and user 7 to form the group for collaborative creation, and research and development where the skills and expertise are complementary to each other.

In another example scenario, the system searches users with the IT skill (C21, user 2), statistics skill (C24, user 2) and Patent skill (user C36, user 3). Accordingly, the system groups user 2, and user 3, in one group for collaborative creation, research and development.

Similarly, in another example scenario, the system searches users with the GIS mapping skill (C32, user 3), Sensor development skill (C33, user 3) and Database management skill (C74, user 7), data integration (c75, user 7), patent (C12, user 1), and Circuit and instrumentation (C71, user 7). Accordingly, the system forms group of user 3, user 7, and user as one group for collaborative creation, research and development.

With each user skill inputs, system attaches meta data so that upon selection of a skill, the system can associate the skill with the corresponding user to form a group.

Example Implementation: Smart Economy Tool

In an example implementation, (un)employed people in the workforce or people in transition between two employment can form a group and work together to develop new product or solve a technically rooted problem using this invention.

Government agencies or business organizations can be benefitted using this model of the current invention. According to this model, an employed or unemployed or under-employed person would be able to work by forming a group of people having similar interest to develop new product or business model. Thus, an unemployed person, during his job transition period, can form a group and work to create new product or solution, while adding skills and experience to his profile by using this model.

In an example scenario, the state or local government can encourage the unemployed person to participate in such model to form a group to collaborate. Incentive may be provided by paying higher salary than just an unemployment benefit. As the users will be creatively engaged in a group to create new product or ideas, investment may be attracted on such product and such investment may be used to pay the group members.

In addition, the product or the solution the group would create would have a positive impact on the economy. The model also provides an interface for the business companies to login their profile and search through different groups formed and invest on a group based on their interest and need. The investment may be used to employ and pay the group members during the period of engagement of the group members.

This business model may also be provided along with services such as job search, resume enhancement, mock interview, etc. to the people who are enrolled in and have formed the group. Thus, the job search time during the unemployment or transition period will be used to engage the person in creative activities such as new product development and creating solution as described above as well as to interact with the professionals who are expert in a technical field in providing such services. The parallel services such as resume building, job and profile matching may also be provided to help the user to land into a new job after some time. This combination of effort will help people who are enrolled as a member and have a formed a group.

Thus, not only unemployed people will be fully paid during their unemployment, they will also be engaged to create products and solutions to the technical, scientific or business problems. At the same time, during the unemployment they may be helped by finding better job match to their profile and by enhancing their skills and profiles when they are engaged in forming group and developing new product or solutions. After a person in the group lands in a new job, he or she can transfer her group responsibility to a new member.

In this way, this model will provide relief to the middle-class people by removing the fear of being unemployed by providing them an opportunity to create new product or services during the unemployment period and by paying them good salary for the creative work they do during this period by attracting investments for new product or ideas they have created as a group. Accordingly, people with skills, interest and expertise will never have to be unemployed. This model will also help grow the economy of the nation by allowing unemployed person to engage in a creative work to create new idea, product or a solution, almost immediately after their release from a job. This tool/model will not only create jobs and new businesses, but also changes the way we look for a job or work for a company or organization. While full implementation of this model will change middle class life by providing them a platform and an opportunity to work almost immediately after their separation from a job. This is the tool that can help us to realize a near zero unemployment (i.e, full employment).

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

I claim:

1. A computer implemented system for grouping a plurality of users based on user expertise, skills and interests, the system comprising:
a server, comprising a processor and a memory, the memory including a non-transitory computer-readable-medium having computer-executable instructions stored therein that, when executed by the processor, cause the processor to:
prompt a user to input a first set of one or more terms in a GUI interface;
compare the first set of one or more inputted terms on the fly with a plurality of stored terms in a database and suggest and display a second set of plurality of selectable terms to the user it response to the user inputting the first set of one or more terms, the second set of the plurality of selectable terms including the user inputted terms;
in response to the user selecting the second set of plurality of selectable terms, storing the second set of plurality of selectable terms and prompting the user to input a third set of one or more terms in a GUI interface;
compare the third set of one or more inputted terms on the fly with a plurality of stored terms m a database and suggest and display a fourth set of plurality of selectable terms to a user in response to the user inputting the third set of one or more terms, the fourth set of plurality of selectable terms including the user inputted terms;
in response to the user selecting the fourth set of plurality of selectable terms, storing the fourth set of plurality of selectable terms and prompting the input a fifth set of one or more terms in a GUI interface;
compare the fifth set of one or more inputted terms on the fly with a plurality of stored terms in a database and suggest and display a sixth set of plurality of selectable terms to a user in response to the user inputting the fifth set of one or more terms, the sixth set of plurality of selectable terms including the user inputted terms;
in response to the user selecting the sixth set of the plurality of selectable terms, storing the sixth set of plurality of selectable terms and prompting the user to input a seventh set of one or more terms in a GUI interface;
compare the seventh set of one or more inputted terms on the fly with a plurality of stored terms in a database and suggest and display an eighth set of plurality of selectable terms to a user in response to the user inputting the seventh set of one or more terms, the eighth set of plurality of selectable terms including the user inputted terms;
in response to the user selecting the eighth set of the plurality of selectable terms, storing the eighth set of plurality of selectable terms and prompting the user to input a ninth set of one or more terms in the GUI interface;
compare the ninth set of one or more inputted terms on the fly with a plurality of stored terms in a database and suggest and display a tenth set of plurality of selectable terms to the user in response to the user inputting the ninth set of one or more terms, the tenth set of plurality of selectable terms including user inputted terms;
in response to the user selecting the tenth set of the plurality of selectable terms, storing the tenth set of plurality of selectable terms; wherein,
the second set of the plurality of terms, the fourth set of the plurality of terms, the sixth set of the plurality of terms, the eighth set of the plurality of terms, and the tenth set of the plurality of terms include meta data related to the user inputting these terms.

2. The system of claim 1, wherein the steps of inputting the terms is repeated until the twelfth set of the plurality of terms, the fourteenth set of the plurality of terms, the sixteenth set of the plurality of terms, the eighteenth set of the plurality of terms, and the twentieth set of the plurality of terms are stored.

3. A method for grouping a plurality of users based on user expertise, skills and interests, the method comprising:
sending a plurality of user skill information (self-skill) and an associated ranking from a large number of users, each user skill information being inputted by the users in separate instances or in separately enabled fields;
sending a plurality of user interest information and associated ranking from the large number of users, each user interest information being, inputted by the users in separate instances or in separately enabled fields;
sending user expertise information and associated ranking from the large number of users, each user expertise information being inputted by the users in separate instances or in separately enabled fields;
sending a plurality of complementary skill information and associated ranking from the large number of users, each user complementary skill information being inputted by the users in separate instances or in separately enabled fields;
sending a plurality of expertise information and associated ranking from the large number of users, each user expertise information being inputted by the users in separate instances or in separately enabled fields;
receiving at least one of the plurality of user skill information (self-skill) and the associated ranking, the plurality of user interest information and the associated ranking, the plurality of complementary skill information and the associated ranking, and the plurality of expertise information and the associated ranking, and forming an instant group formation (IGF) matrix by,
storing in a memory the interest information, skill information, complementary skills information, and expertise information corresponding to a first user in a first row in columns 1-n, with ranking;
storing in the memory the interest information, skill information, complementary skills information, and expertise information corresponding to a second user in a second row in columns 1-n with ranking;
storing in the memory the interest information, skill information, complementary skills information, and expertise information corresponding to a third user in a third row in columns 1-n with ranking;
storing in the memory the interest information, skill information, complementary skills information, and expertise information corresponding to a fourth user in a fourth row in columns 1-n with ranking;
storing in the memory the interest information, skill information, complementary skills information, and expertise information corresponding to a fifth user in a fifth row in columns 1-n with ranking;
repeating the steps of storing, in the memory, the interest information, skill information, complementary skills information, and expertise information corresponding to each of the remaining users until all the user information is stored:, and
forming a first group of users based on the self-skills, complementary skills, expertise and interest in such a way that each of the complementary skills associated with a same user (a first member of the group) is searched in the self-skill columns of remaining users wherein first, the first column is searched for the complementary skills, if a corresponding complementary skill is found in the first column, the corresponding user is selected as a second member of the group, if the complementary skill is not found in the first column, the second column is searched for the same complementary skill and the corresponding user will be selected as the second member of the group, the process is repeated until all the complementary skills and expertise are identified, and a group is formed wherein the formed group incorporates all the necessary skills and expertise to complete a function.

4. The method of claim 3, wherein the associated ranking indicates the user command or strength on the skills in numerical representation with 1 being the best and 10 being the least in ranking.

5. The method of claim 3, wherein the self-skills, Complementary skills or expertise are selected from the order of best available rankings to the least available rankings.

6. A computer implemented system for grouping a plurality of users based on user expertise, skills and interests, the system comprising:
a server, comprising a processor and a memory, the memory including a non-transitory computer-readable-medium having computer-executable instructions stored therein that, when executed by the processor, causes the processor to:
receive, from each user from a plurality of users, a first set of a plurality of a riser information associated with the user, the first set of a plurality the user information further including ranking for the each of the user information;
receive, from each of the plurality of users, a second set of information determined by the user, the second set of information including information associated with the users other than the user himself and ranking for the each of the second set of information; and
form a group of users comprising a first user and a second group of users, the first user being selected from one of the plurality of users based on a criteria and the second group of users being selected based on the second set of information determined by the first user.

7. The system according to claim 6, wherein the first set of the plurality of user information are a set of skill information associated with the user (i.e., self-skill), the set of skill information being ranked from 1-5 with 1 being the best skill.

8. The system according to claim 6, wherein the second set of the plurality of user information are a set of skill information that the user is looking for in other users (i.e., the complementary skill set), the complementary skill set being ranked from 1-5 with 1 being the best skills.

9. The system according to claim 6, wherein forming the group of users comprises
selecting the second group of users,
by,
searching each information of the second set of information determined by the first user, in the self-skill set of information inputted by the other users in the order of ranking, and
if the searched information is found, selecting the corresponding users as member of the second group of users; and
forming the group of users by including first user and the second group of users.

10. The system of claim 6, wherein each formed group is displayed along with an overall score of the group.

11. The system of claim 6, wherein the overall score of the group is updated based on the score provided by second set of a plurality of users.

12. The system of claim 6, wherein the system is configured to mutually swap individual users (a member of a group) with another individual member of the group.

13. The system according to claim 8, wherein the second group of the plurality of users are selected
by,
in a first step, searching a complementary skill in rank 1. of the users self-skill information and if a corresponding complementary skill is found in rank 1, the corresponding user is selected, then,
repeating the first step all the complementary skills are searched in rank 1, and the corresponding users are selected, and if all the complementary skills are not found in rank 1, repeating step 1 in rank 2, rank 3, rank 4 or rank 5 in order until all the complementary skills are identified.

14. The system according to claim 13, wherein the second group of the plurality of users are selected
by,
in a second step, searching a complementary skill in rank 2 of the users self-skill information if a corresponding complementary skill is not found in rank 1, and if the complementary skill is found in rank 2, the corresponding user is selected, then, repeating the second step until all the complementary skills are searched in rank 2, and the corresponding users are selected.

15. The system according to claim 14, wherein the second group of the plurality of users are selected
by,
in a third step, searching a complementary skill in rank 3 of the users self-skill information if a corresponding complementary skill is not found in rank 2, and if the complementary skill is found in rank 3, the corresponding user is selected, then,
repeating, the third step until all the complementary skills are searched in rank 3, and the corresponding users are selected; and
repeating third step with remaining ranks until all the complementary skills are found and selecting the corresponding users.

16. The system according to claim 14, wherein the ranking information is from 1-5, 1 being the best representative of the user information.

17. The system according to claim 14, wherein the user information is the information inputted by the user in a graphical user interface, each user information being inputted in separately enabled interface and the interface further comprising ranking information selectable between 1-10.
